(19) United States
(12) Patent Application Publication
(10) Pub. No.: US 2005/0260321 A1
(43) Pub. Date: Nov. 24, 2005

(54) Low carbohydrate pasta

(76) Inventor: Mark E. Weston, Garfield, MN (US)

Correspondence Address: MERCHANT & GOULD PC, P.O. BOX 2903, MINNEAPOLIS, MN, 55402-0903, US

(21) Appl. No.: 11/076,442

(22) Filed: Mar. 9, 2005

Related U.S. Application Data
(60) Provisional application No. 60/551,461, filed on Mar. 9, 2004.

(51) Int. Cl. A23L 1/00

(52) U.S. Cl. 426/557

(57) ABSTRACT

An edible pasta product containing semolina flour, eggs, and soy protein isolate is disclosed. In certain embodiments the pasta product contains at least 5 percent semolina flour, less than 35 percent by dry weight whole pasteurized eggs, and from 20 to 40 percent soy protein isolate. The edible pasta product can also contain, for example, citric acid, flavoring components, and thickening agents.

### REFERENCE TO PRIORITY APPLICATION

This application claims the benefit under 35 U.S.C. § 119(e) of Provisional Application No. 60/551,461, filed Mar. 9, 2004, which is incorporated by reference herein in its entirety.

### BACKGROUND

The present invention relates to pasta or noodle products that are suitable for people restricted to, or desiring, reduced-carbohydrate diets. Low-carbohydrate diets are suitable for people who cannot consume large amounts of foods containing refined carbohydrates, such as sugars. Low-carbohydrate diets differ from those advocated by many traditional nutrition authorities who favor diets based on the so-called “food pyramid”, the foundation of which rests on consumption of large amounts of high-carbohydrate foods.

The food pyramid lists foods without accounting for a need for restriction on carbohydrate intake. Thus, all fruits and vegetables and grains figure prominently in that view of a healthy diet. Low-carbohydrate diets, on the other hand, typically prohibit or severely limit foods containing starches and sugars, including all grains, cereals, potatoes, and foods made with them. Allowed foods for a low-carbohydrate weight loss diet include meats, poultry, fish, shellfish, fats/oils, some dairy products (heavy cream, butter, and some cheeses), all green and other non-starchy vegetables, and a few other relatively low-carbohydrate fruits.

There is a need for low-carbohydrate foods of greater variety than are currently available to enable people on low-carbohydrate diets to eat many of the foods to which they are accustomed but which are on the restricted or prohibited list. Among the needed new foods are low-carbohydrate pasta products.

### SUMMARY OF THE INVENTION

The present invention is directed, in part, to an edible pasta product containing at least 5 percent semolina flour, less than 35 percent by dry weight whole pasteurized eggs, and from 20 to 40 percent soy protein isolate. The edible pasta product can also contain, for example, citric acid, flavoring components, and thickening agents. In certain embodiments the pasta product contains from 20 to 40 percent soy protein isolate and from 5 to 25 percent semolina. The pasta product can also contain, for example, from 30 to 35 percent soy protein isolate, from 10 to 20 percent semolina flour, from 25 to 35 percent whole pasteurized liquid eggs containing up to 15 percent water, and from 10 to 25 percent water.

The above summary of the present invention is not intended to describe each disclosed embodiment or every implementation of the present invention. The Detailed Description which follows more particularly exemplify these embodiments.

### DETAILED DESCRIPTION OF THE INVENTION

The present invention is directed, in part, to a low-carbohydrate pasta or noodle product. The invention is also directed to a process for preparing a low-carbohydrate pasta or noodle product, and to a dry mix for preparing a low-carbohydrate pasta or noodle product. By the term “low-carbohydrate” is meant an amount of a food in a 100 gram serving which supplies less than about one-fourth of the daily recommended intake of carbohydrate for a low-carbohydrate diet. Generally, a “low-carbohydrate diet” is defined as any diet that includes fewer than 100 grams of carbohydrate for an average person per day. Thus, all of the products of the invention have carbohydrate in minor amounts, preferably in amounts of no more than 15 grams per serving. Advantageously, the carbohydrate content is fewer than 15 grams per serving, typically fewer than 10 grams per serving, and in some implementations fewer than 5 grams per serving. Typically, the amount of carbohydrates is from 1 to 15 grams per serving.

The term “pasta” is meant to include all shapes and forms typically identified as spaghetti, lasagna, capelleti, spatzle, tagiatelli, fettuccini, fettucce, bucatini, macaroni, penne, lumache, conchiglie, shells, rigatoni, farfalle, fusilli, spirals, twists, ziti, zita, gnocchi, angolotti, tortellini, tortoloni, ravioli, soya shells, tubetti, soup pasta, noodles, spaghettini, vermicelli, cappelini, angel hair, pappardelle and any and all other shapes of pasta typically made of durum-wheat semolina. The pasta can be supplied in dried or fresh form for packaging. In the case of dried pasta, it can be prepared by any suitable process, such as drum drying, spray drying, freeze drying, and the like.

The pasta of the invention typically contains a purified soy protein isolate or a whey protein isolate. The purified soy protein isolate can be purchased, for example, from Protient, Inc. of St. Paul, Minn. The soy protein isolate is produced by water filtration into a highly concentrated form with high nutritive value and a clean flavor profile for use in a wide variety of applications. Advantageously the soy protein isolate is low in sodium, in some implementations less than 0.05 percent sodium. The pasta typically contains at least 15 percent soy protein isolate, more commonly more than 20 percent soy protein isolate, and often more than 25 percent soy protein isolate. In many implementations the amount of soy protein isolate is less than 40 percent, and often less than 35 percent. In certain implementations the amount of soy protein isolate is from 20 to 40 percent, and sometimes from 25 to 35 percent.

The pasta also generally contains semolina, typically at least 5 percent semolina, and more typically at least 10 percent semolina. The amount of semolina is generally less than 25 percent, often less than 20 percent, and frequently less than 15 percent. In some implementations the amount of semolina is from 5 to 25 percent, and frequently from 10 to 15 percent.

In some implementations the invention further includes eggs within the pasta. In general the amount of eggs is less than 35 percent of the pasta by dry weight, frequently less than 25 percent, and often less than 15 percent. The eggs can be supplemented with water and citric acid in some implementations.

In certain embodiments of the invention the pasta contains purified soy protein isolate, semolina, eggs, and citric acid. In some implementations the pasta contains from 20 to 40 percent soy protein isolate, often from 25 to 35 percent soy protein isolate; from 5 to 25 percent semolina, often from 10 to 15 percent semolina; and from 20 to 40 percent liquid eggs, often from 25 to 35 percent liquid eggs, and sometimes further containing water and citric acid.

An example embodiment includes 31.3 percent soy protein isolate, 15.6 percent semolina, 31.3 percent whole pasteurized liquid egg containing 15 percent water and citric acid, and 21.9 percent water. In an alternative embodiment, the pasta contains about 31 percent soy protein isolate, about 16 percent semolina, about 8 percent whole pasteurized powdered egg, and about 45 percent water. The volume of water can be adjusted as necessary depending on the type of extrusion or shape desired.

The pasta should generally be cooked within 24 hours of production for the best flavor, texture and color. The pasta should cook for as long as necessary, depending on the desired texture. The pasta should then be chilled by rinsing with water, and then strained and coated with any desired oil or other product to prevent the pasta from sticking together. The pasta should then be put into the final desired finished product, such as a prepared meal containing pasta sauce and/or vegetables, and frozen. The final desired product can be frozen entrees, used for dehydration to create a dry final product, frozen and sold as pasta, or fried in oil to create a crisp texture.

In addition to the above ingredients, the low-carbohydrate foods and mixes of the invention can comprise a flavoring component consisting of spices. Preferred among the various flavoring components are those that are available in dry form. Some of those preferred are allspice, basil leaves, caraway seeds, celery salt, chervil, cinnamon, coriander, cumin, curry powder, dill weed, mustard, fennel seed, garlic, ginger, gumbo file, lemon, nutmeg, onion, oregano, paprika, parsley, black pepper, red pepper, white pepper, tarragon, rosemary, thyme, turmeric, saffron, egg yolk, milk, tomato and mixtures of at least two of these. Any other spices and vegetable products available in dry form can also be employed as long as they don't unduly increase the hygroscopicity of the composition.

For example, in addition to black pepper, there are various dried bell peppers, hot peppers of a number of varieties, and the like. Various other spices can also be employed as desired for taste. It is important that the various flavorings be capable of dry blending, so granular or particulate forms are desired. However, some materials are important also for their mouth feel when hydrated or their visual impact, and these factors will be taken into account for them. Salt is also preferred at suitable levels for good taste, e.g., up to about 2 percent, but can be reduced as desired. Salt substitutes can also be employed at suitable levels.

The compositions of the invention can also include thickening agents, which will preferably be one or a combination which is easily hydratable and provides the mouth feel desired for the final food product. Preferably, the thickening agent will comprise, in dry form, a member selected from the group consisting of flour, starch, vegetable gums and hydrocolloids, including xanthan gum, alginates, gelatin, pectin, and mixtures of at least two of these and their substitutes or equivalents.

The process of the invention entails mixing the ingredients in a manner that provides a uniform blend having the desired textural properties. The process is exemplified below. In one aspect, the process for preparing a low-carbohydrate pasta product utilizing the mix comprises extruding the mix, and cutting the extruded mix into shapes suitable for boiling.

Typical extruders are single screw extruders of the Braebender type, such as are widely used in the food industry, and double screw devices. Also, complex extruders can be effective. The following examples are provided to further illustrate and explain a preferred form of the invention and are not to be taken as limiting in any regard unless otherwise indicated.

### Example 1

A mixture was prepared containing 31.3 percent soy protein isolate available from Protient of St. Paul, Minn., 15.6 percent semolina, 31.3 percent whole pasteurized liquid egg containing 15 percent water and citric acid, and 21.9 percent water. The resulting mixture was elastic. The pasta extruded fine without leaving the pasta rough edged. When cooked, the pasta had a minimal rubbery texture and a light color. A shelf life test of the raw pasta was run and the pasta lasted 21 days, after which it started to grow mold. Each day under refrigeration of less than 40 degrees caused the pasta color to darken and then leave small black spots in the pasta, but not as many as in Example 2.

To test quality and shelf life, samples of the pasta were cooked for one minute, two minutes, three minutes, four minutes, five minutes and six minutes, then chilled, lightly oiled, sealed and put in the freezer. The resulting pasta had a high quality texture, taste, and mouth feel. The varied cooking times reacted the same as conventional semolina pasta when semolina pasta is cooked for the same amount of time then left fresh, not frozen. The pasta had an excellent flavor and color.

### Example 2

A mixture was prepared containing 31.3 percent soy protein isolate, 15.6 percent semolina, 7.8 percent whole pasteurized powdered egg, 45.3 percent water. The resulting mixture was elastic. The pasta extruded fine without leaving the pasta rough edged. When cooked the pasta had a good texture, and the color was light.

The pasta lasted 21 days under refrigeration before starting to show noticeable mold growth. Each day under refrigeration of less than 40 degrees caused the pasta color to darken and then leave small black spots. Samples of the pasta were cooked for one minute, two minutes, three minutes, four minutes, five minutes and six minutes, then chilled, lightly oiled, sealed and put in the freezer. The result was pasta with a texture that was desirable and had excellent mouth feel. The varied cooking times reacted the same as conventional semolina pasta when semolina pasta is cooked for the same amount of time then left fresh, not frozen. The pasta had an excellent flavor and color, although the flavor Was not as good as that in Example 1.

### Comparative Example 1

A mixture containing 37.5 percent soy protein isolate, 9.4 percent semolina, 21.9 percent whole fresh eggs, 6.3 percent vital wheat gluten, and 25 percent water was prepared. The result was very sticky and elastic. The pasta would not extrude without leaving the pasta rough edged. When cooked the pasta had a rubber-type texture.

### Comparative Example 2

A mixture was prepared containing 31.3 percent soy protein isolate, 15.6 percent semolina, 31.3 percent whole fresh eggs, 6.3 percent vital wheat gluten, and 15.6 percent water. The result was elastic. The pasta extruded fine without leaving the pasta rough edged. However, when cooked the pasta had a rubber-type texture. The pasta was cooked and then rapidly chilled and coated with a light coating of oil. This pasta was placed in a sealed container and put under refrigeration and checked daily. By the third day the elasticity started to break down but still left a strange texture in the mouth when eating. By day five the pasta was discarded because the texture and flavor were not palatable.

### Comparative Example 3

A mixture was prepared containing 31.3 percent soy protein isolate, 15.6 percent semolina, 31.3 percent whole pasteurized liquid egg containing 15 percent water and citric acid, 6.3 percent vital wheat gluten, 15.6 percent water. The result was elastic. The pasta extruded fine without leaving the pasta rough edged. However, when cooked the pasta had a rubber-type texture. This pasta was placed in a sealed container and put under refrigeration and checked daily. By the third day the elasticity started to break down but still left a strange texture in the mouth when eating. By day seven the pasta was discarded because the texture and flavor were not palatable. Samples of the pasta were placed in a freezer for a day then cooked as described above.

### Comparative Example 4

A mixture containing 29.4 percent soy protein isolate, 14.7 percent semolina, 7.6 percent powdered whole pasteurized egg, 5.8 percent vital wheat gluten, and 42.7 percent water was prepared. The resulting pasta was elastic. The pasta extruded fine without leaving the pasta rough edged. When cooked the pasta had a rubber-type texture. This pasta was placed in a sealed container and put under refrigeration and checked daily. By the third day the elasticity started to break down but still left a strange texture in the mouth when eating. By day seven the pasta was discarded because the texture and flavor were not palatable. Samples of the pasta were placed in a freezer for a day then cooked as described above.

### Comparative Example 5

A mixture containing 29.2 percent soy protein isolate, 14.6 percent semolina, 7.3 percent powdered whole pasteurized egg, 5.8 percent vital wheat gluten, 42.3 percent water, and 0.73 percent sodium alginate was prepared. This formula was an attempt to remove the elastic texture. The pasta would not extrude.

### Comparative Example 6

A mixture containing 28.8 percent soy protein isolate, 21.6 percent semolina, 28.8 percent whole pasteurized liquid egg containing 15 percent water and citric acid, 20.1 percent water, and 0.7 percent sodium alginate was prepared. This formula was an attempt to remove the elastic texture. The pasta would not extrude.

The present invention should not be considered limited to the particular examples described above, but rather should be understood to cover all aspects of the invention as fairly set out in the attached claims. Various modifications and equivalent processes, as well as numerous structures to which the present invention may be applicable, will be readily apparent to those of skill in the art to which the present invention is directed upon review of the instant specification.

1. An edible pasta product comprising:
at least 5 percent semolina flour;
less than 35 percent by dry weight whole pasteurized eggs; and
from 20 to 40 percent soy protein isolate.

2. The edible pasta product of claim 1, further comprising citric acid.

3. The edible pasta product of claim 1, further comprising a flavoring component.

4. The edible pasta product of claim 3, wherein the flavoring component is selected from allspice, basil leaves, caraway seeds, celery salt, chervil, cinnamon, coriander, cumin, curry powder, dill weed, mustard, fennel seed, garlic, ginger, gumbo file, lemon, nutmeg, onion, oregano, paprika, parsley, black pepper, red pepper, white pepper, tarragon, rosemary, thyme, turmeric, saffron, egg yolk, milk, tomato and mixtures thereof.

5. The edible pasta product of claim 1, further comprising a thickening agent.

6. The edible pasta product of claim 5, wherein the thickening agent is selected from flour, starch, vegetable gums, hydrocolloids, and combinations thereof.

7. The edible pasta product of claim 5, wherein the thickening agent is selected from xanthan gum, alginates, gelatin, pectin, and mixtures thereof.

8. The edible pasta product of claim 1, further comprising at least 5 percent vital wheat gluten.

9. An edible pasta product comprising:
from 20 to 40 percent soy protein isolate; and
from 5 to 25 percent semolina.

10. The edible pasta product of claim 9, further comprising citric acid.

11. The edible pasta product of claim 9, wherein the pasta product contains from 25 to 35 percent soy protein isolate.

12. The edible pasta product of claim 9, wherein the pasta product contains from 30 to 35 percent soy protein isolate.

13. The edible pasta product of claim 9, further comprising from 5 to 15 percent by dry weight whole pasteurized powdered eggs.

14. An edible pasta product comprising:
from 30 to 35 percent soy protein isolate;
from 10 to 20 percent semolina flour;
from 25 to 35 percent whole pasteurized liquid eggs containing up to 15 percent water; and
from 10 to 25 percent water.

15. The edible pasta product of claim 14, further comprising citric acid.

16. The edible pasta product of claim 14, wherein the pasta product contains from 31 to 33 percent soy protein isolate.

17. The edible pasta product of claim 14, wherein the pasta product contains from 12 to 18 percent semolina flour.

18. The edible pasta product of claim 14, further comprising a thickening agent.

19. The edible pasta product of claim 18, wherein the thickening agent is selected from xanthan gum, alginates, gelatin, pectin, and mixtures thereof.

20. The edible pasta product of claim 14, further comprising at least 5 percent vital wheat gluten.
